(19) United States
(12) Patent Application Publication
(10) Pub. No.: US 2017/0087576 A1
(43) Pub. Date: Mar. 30, 2017

(54) SMART HYDROGEN WATER MIST SPRAY

(71) Applicant: SHENZHEN COSBEAUTY CO., LTD, Nanshan (CN)

(72) Inventors: Ziran Fang, Shenzhen (CN); Wanfu Huang, Shenzhen (CN)

(21) Appl. No.: 15/203,058

(22) Filed: Jul. 6, 2016

(30) Foreign Application Priority Data
Sep. 25, 2015 (CN) 201520755195.0

(51) Int. Cl. B05B 12/12; G08B 5/36; A45D 44/00; B05B 11/00; A45D 34/04; H04W 4/00; G05D 7/06

(52) U.S. Cl. CPC B05B 12/12; H04W 4/008; G08B 5/36; G05D 7/0676; B05B 11/0056; A45D 34/04; A45D 44/00; A45D 2044/007

(57) ABSTRACT

An intelligent mist spray skin moisturizer device including an outer shell having a plurality of internal components, the plurality of internal components including a power module, a skin moisture testing module, a water misting module including a liquid tank, a mist spray head coupled to the liquid tank, and a water mist generation device coupled to mist spray head, a radio communication module, and a control module communicatively coupled to the water misting module, the control module operably configured to receive data from the skin moisture testing module via the radio communication module, process the data from the skin moisture testing module, and instruct the water misting module to execute a misting process based on the data output from the skin moisture testing module.

### CROSS-REFERENCE TO RELATED APPLICATION

This application claims priority to Chinese Patent Application No. 201520755195.0, filed Sep. 25, 2015, the entirety of which is incorporated by reference.

### FIELD OF THE INVENTION

The present invention relates generally to skin moisturizing, and, more particularly, relates to an intelligent skin moisturizing device.

### BACKGROUND OF THE INVENTION

Skin moisturizing sprayers are popular moisturizing products on the market these days. Such sprayers have been widely accepted and popular, especially in the summer and fall when air is dry. This has become a must-have gadget for skin care among users. Users may use such sprayers whenever and wherever they want by pressing the spray head to release either a fixed amount or constant amount of water as long as the spray head is depressed. Skin moisture differs, however, from person to person. Moreover, even for the same person, his or her skin moisture differs from time to time as well. Thus, the previous method of water spraying is not reasonable as it will not achieve the optimal moisturizing results and will not benefit the user in the long-run.

Therefore, a need exists to overcome the problems with the prior art as discussed above.

### SUMMARY OF THE INVENTION

The invention provides a smart water mist spray device that overcomes the hereinafore-mentioned disadvantages of the heretofore-known devices and methods of this general type and provides a smart water mist spray device configured to emit water based on the requirements of an individual user's skin at any given time.

With the foregoing and other objects in view, there is provided, in accordance with the invention, an intelligent mist spray skin moisturizer device having an outer shell with a plurality of internal components that include a power module, a radio communication module coupled to the power module, a skin moisture testing module coupled to the radio communication module, a water misting module, and a control module communicatively coupled to the water misting module. The water misting module includes a liquid tank, a mist spray head coupled to the liquid tank, and a water mist generation device coupled to mist spray head. The control module is operably configured to receive data from the skin moisture testing module via the radio communication module, process the data from the skin moisture testing module, and instruct the water misting module to execute a misting process based on the data from the skin moisture testing module.

In accordance with yet another feature, an embodiment of the present invention also includes a liquid level window disposed on the outer shell. Also, the liquid level window may be disposed on a side of the upper cap.

In accordance with yet another feature, an embodiment of the present invention also includes an upper cap and a lower cap separated by and removably coupled to a body.

In accordance with an additional feature, an embodiment of the present invention also includes an indicator light coupled to the water misting module, wherein the indicator light is operably configured to indicate a misting mode of the water misting module.

In accordance with a further feature of the present invention, the radio communication module is a Bluetooth module.

In accordance with another feature, an embodiment of the present invention also includes an indicator light communicatively coupled to the Bluetooth module.

In accordance with yet another feature, an embodiment of the present invention includes a Bluetooth module on/off switch disposed on a bottom portion of the outer shell. The present invention may also include the device having a battery recharging port.

Although the invention is illustrated and described herein as embodied in a smart water mist spray device, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. In this document, the term “longitudinal” should be understood to mean in a direction corresponding to an elongated direction of the outer shell. The terms “program,” “software application,” and the like as used herein, are defined as a sequence of instructions designed for execution on a computer system. A “program,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a front elevational view of an outer shell of a smart water mist spray device;

FIG. 2 is a plan view of a bottom of the outer shell of the smart water mist spray device of FIG. 1;

FIG. 3 is an exploded view of a plurality of internal components of the smart water mist spray device of FIG. 1; and

FIG. 4 is a block diagram of an exemplary operation process of the smart water mist spray device of FIG. 1.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

The present invention provides a novel and efficient moisturizing spray device that provides an intelligent solution in skin moisturizing by first analyzing a user's skin moisture level, then applying personalized moisturizing solutions to achieve the optimal moisturizing results for the user. Embodiments of the invention provide an intelligent mist spray skin moisturizing device having an outer shell including a plurality of internal components. In one embodiment, the internal components include a skin moisture testing module, a water misting module, a radio communication module, a control module, and a power module. The water misting module may contain a liquid tank, a water mist generation device, and a mist spray head. The control module is configured to receive and process data from the moisture testing module and start the misting process based on the data. Thus, the moisturizing spray device combines moisture testing, mist regulating, controlling, and radio communication. In one embodiment, the moisturizing spray device first analyzes the skin moisture, and then provides a personalized misting spray solution. When compared to traditional methods which are configured to spray a constant amount of water with each use, the moisturizing spray device described herein is advantageous as the moisturizing spray device is configured to spray just the right amount of moisturizer that the skin needs at any given moment to achieve more precise and desirable moisturizing results.

In one embodiment, the moisturizing spray device includes a window on the outer shell to monitor the remaining liquid level within its liquid holding tank.

In one embodiment, the moisturizing spray device may have an upper cap, a body, and a lower cap. The upper and the lower cap can be removed from the top and bottom sides of the sprayer. The liquid level window may be disposed on the side of the upper cap.

In one embodiment, the moisturizing spray device features an indicator light for one or more misting modes.

In one embodiment, the radio communication module of the moisturizing spray device is a Bluetooth module. The moisturizing spray device may feature an indicator light for Bluetooth operation.

In one embodiment, the moisturizing spray device features an on/off switch for the Bluetooth module disposed on the bottom of the outer shell.

In one embodiment, the moisturizing spray device features a battery recharging port to recharge the device battery.

The new utility design described herein offers strong advantages and better results when compared to the current existing technology. In particular, this new design first analyzes a user's skin moisture level. Thereafter, the moisturizing spray device provides a personalized moisturizing solution for the user by utilizing the moisturizing spray device's skin moisture testing module, water misting module, radio communication module, control module, and power module. When compared to traditional methods which spray a constant amount of water every time, this new utility design advantageously sprays the suitable amount that the skin needs at the moment of testing to achieve more precise and desirable moisturizing results.

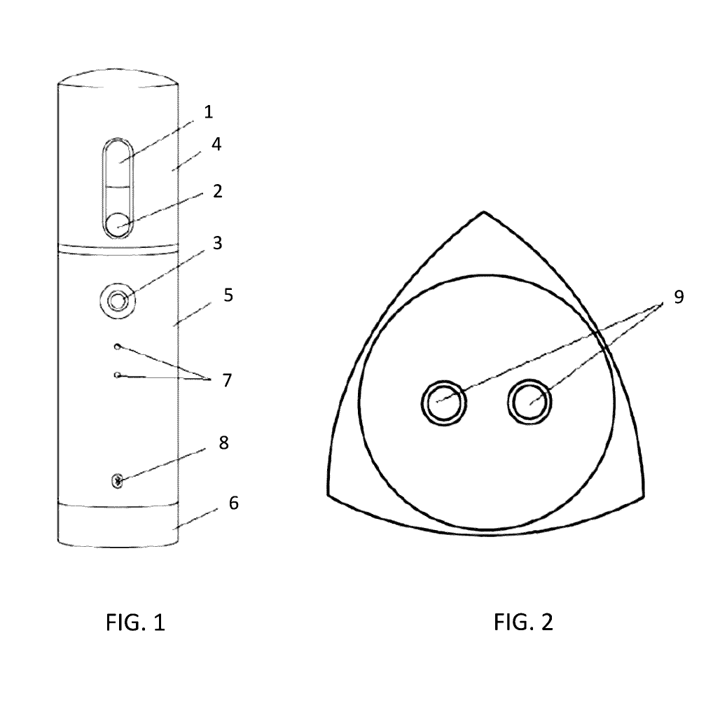

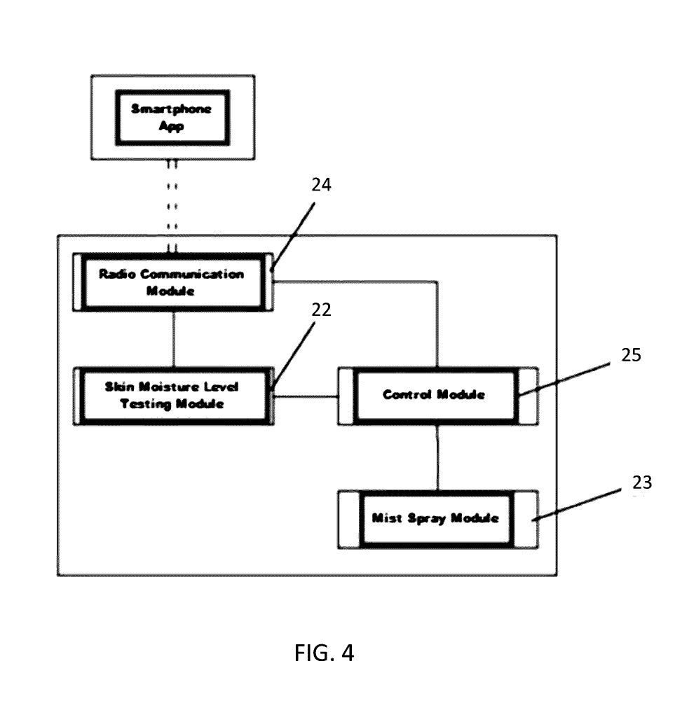

With reference now to FIGS. 1-4, various embodiments of the present invention are shown. FIGS. 1-4 show several advantageous features of the present invention, but, as will be described below, the invention can be provided in several shapes, sizes, combinations of features and components, and varying numbers and functions of the components. In one embodiment, the smart hydrogen water mist spray device includes an outer shell having a plurality of internal components. The internal components may include a skin moisture testing module (22), a water misting module (23), a radio communication module (24), a control module (25), and a power module (20).

In one embodiment, the skin moisture testing module (22), the water misting module (23), and the radio communication module (24) are all connected to the control module (25). The skin testing module (22) contains testing nodes (9). The water misting module (23) may contain a liquid holding tank (91), a mist generator, and a mist spray head (2). The control module (25) receives and analyzes the results gathered by the skin moisture testing module (22) and provides a user with a personalized moisturizing solution using the water misting module (23). The radio communication module (24) may be a Bluetooth module that pairs with a Smartphone via a Bluetooth connection. In one embodiment, the Smartphone includes a software application installed therein which connects to the mist spray device. In use, a user may choose a skin testing location on the software application and hold the device to the desired testing location with the testing nodes (9) contacting the user's skin. The mist spray device and software application will test the skin moisture level multiple times. Finally, the mist spray device will provide a personalized moisturizing solution for the user based on the test results to achieve optimal moisturizing results.

In one embodiment, the misting process and design include the outer shell having an upper cap (4), a main body (5), and a bottom cap (6). The upper cap (4) and the lower cap (6) can be removed from the main body (5). The upper cap (4) may contain a window to monitor the remaining water level of the liquid holding tank. In one embodiment, the misting spray device includes two misting modes, a low misting mode and a high misting mode. The misting mode indicator (7) will display the mode selected by the program.

The skin testing contact nodes (9) may be exposed on the bottom of the device. The misting spray head (2) may be exposed to the side of the main body (5). In one embodiment, a Bluetooth on/off switch is disposed at the bottom of the main body (5). The charging port (20) may also be disposed (DC connector) at the bottom of the main body (5). In one embodiment, the Bluetooth switch is disposed inside the lower cap (6). The main body (5) may also contain the Bluetooth indicator (8).

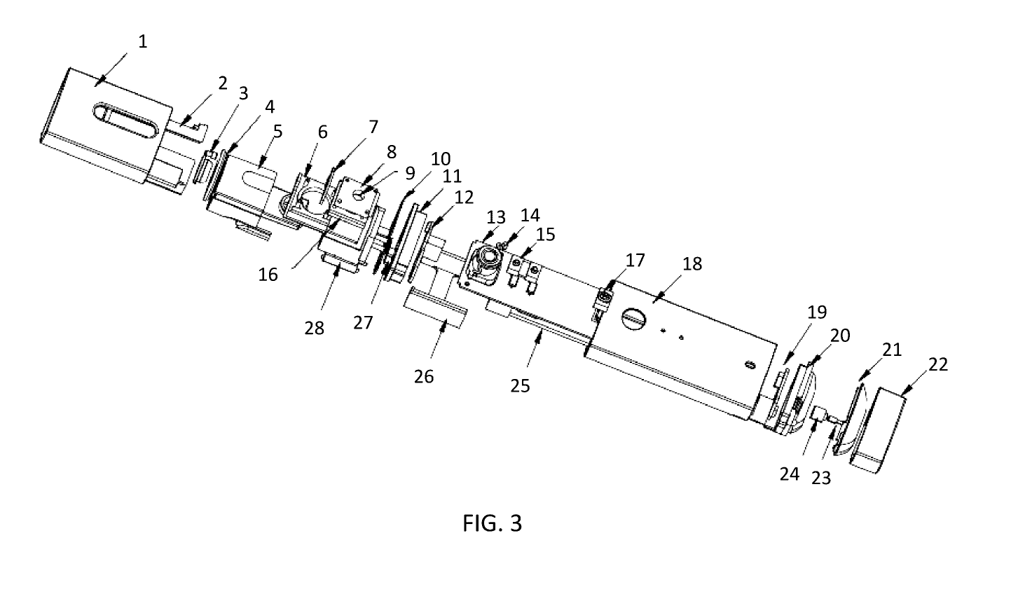

With reference to FIG. 3, the major components of the misting spray device are depicted in an exploded view. More specifically, in one embodiment, FIG. 3 includes the upper cap (4), the outer shell (5), the bottom cap (6), an internal tank (10), a tank cover (11), a tank plug (12), an LED PCB board (13), a misting plate (14), a mist generation device (15), such as, for example, a nozzle, an o-ring (16), a PCB module (18), an on/off switch (3), a misting mode indicator (7), a Bluetooth indicator (8), a charging port PCB board (21), etc. In one embodiment, the anchor plate (19) anchors the PCB boards, a liquid holding tank (1) and the upper and lower caps 4, 6.

In one embodiment, the operation of the device includes the following steps. In step one, a user may download and install the software application on a Smartphone. In step two, the user may remove the lower cap, turn on the Bluetooth power of the misting spray device, turn on the Bluetooth on the Smartphone, and then pair the misting spray device to the Smartphone. Once the two are successfully paired via the Bluetooth indicator, the misting spray device will turn on. In step three, the user may choose a desired test location on the software application and then hold the misting spray device with the skin testing contact nodes to the targeted skin area so that the application can conduct multiple tests. Advantageously, the misting spray device can automatically calculate the optimal amount of moisture needed for the user. Of course, the user should confirm that the misting spray device and Smartphone are paired during this process so that the misting spray device can execute its intended purposes.

Step four may include a user closing the lower cap and pressing the power button. The misting mode indicator should turn on with the misting spray device being in intelligent mode. The most recent testing results will be uploaded to the misting spray device automatically by the application, and the misting spray device will retain this memory for approximately five minutes. Within this timeframe, the user can start using the moisturizing mist sprays.

In step five, when using the mist spray, a user may hold the misting spray device approximately 10 mm away from the skin and start the misting process. When the misting process is finished, the misting spray device will turn itself off automatically. The intelligent misting spray device has two modes, low and high. A user may press the misting spray device once for the low mode and twice for the high mode. In one embodiment, the low mode is approximately 1 mL/sec. and the high mode is approximately 2 mL/sec. In other embodiments, the modes may be outside of these flow rates. In a preferred embodiment, the misting time is different for the two modes.

The focus of this invention is by first analyzing the skin moisture, a personalized misting spray solution can be applied. When compared to traditional methods which spray a constant amount of water every time, the new utility design herein is intelligent as it sprays the right amount that the skin needs at that very moment, to achieve the optimal moisturizing results.

The description provided herein is provided for exemplary purposes and is not intended to be limiting. Alterations for the production models are within the scope of this invention.

What is claimed is:

1. An intelligent mist spray skin moisturizer device comprising:
an outer shell including a plurality of internal components, the plurality of internal components including:
a power module;
a radio communication module coupled to the power module;
a skin moisture testing module coupled to the radio communication module;
a water misting module having:
a liquid tank;
a mist spray head coupled to the liquid tank; and
a water mist generation device coupled to mist spray head; and
a control module communicatively coupled to the water misting module, the control module operably configured to:
receive data from the skin moisture testing module via the radio communication module;
process the data from the skin moisture testing module; and
instruct the water misting module to execute a misting process based on the data from the skin moisture testing module.

2. The intelligent mist spray skin moisturizer device according to claim 1, further comprising:
a liquid level window disposed on the outer shell.

3. The intelligent mist spray skin moisturizer device according to claim 2, further comprising:
an upper cap and a lower cap separated by and removably coupled to a body.

4. The intelligent mist spray skin moisturizer device according to claim 3, wherein:
the liquid level window is disposed on a side of the upper cap.

5. The intelligent mist spray skin moisturizer device according to claim 1, further comprising:
an indicator light coupled to the water misting module, the indicator light operably configured to indicate a misting mode of the water misting module.

6. The intelligent mist spray skin moisturizer device according to claim 1, wherein:
the radio communication module is a Bluetooth module.

7. The intelligent mist spray skin moisturizer device according to claim 6, further comprising:
an indicator light communicatively coupled to the Bluetooth module.

8. The intelligent mist spray skin moisturizer device according to claim 6, further comprising:
a Bluetooth module on/off switch disposed on a bottom portion of the outer shell.

9. The intelligent mist spray skin moisturizer device according to claim 1, further comprising:
a battery recharging port.
